(19) United States
(12) Patent Application Publication
(10) Pub. No.: US 2013/0052085 A1
(43) Pub. Date: Feb. 28, 2013

(54) MICROFLUIDIC SYSTEM COMPRISING A LIGHT EMITTING DEVICE

(71) Applicant: Kasper Paasch, Soenderborg (DK)

(72) Inventor: Kasper Paasch, Soenderborg (DK)

(73) Assignee: Danfoss A/S, Nordborg (DK)

(21) Appl. No.: 13/519,692

(22) PCT Filed: Jan. 12, 2011
(86) PCT No.: PCT/DK2011/000001

§ 371 Date: Oct. 2, 2012

(30) Foreign Application Priority Data
Jan. 13, 2010 (DK) PA 2010 00023

(51) Int. Cl. G01N 21/75

(52) U.S. Cl. 422/82.09

(57) ABSTRACT

The present invention relates to especially microfluidic analysis systems where the emitted light of a emitting source is measured by optic detection, and where a transparent body separates the emitting source from the optic detector. The invention especially relates to optic calibration of the device, the calibration being related to changes in the transparency of the transparent body and/or changes in the temperature of the emitting source.

### CROSS REFERENCE TO RELATED APPLICATIONS

This application is entitled to the benefit of and incorporates by reference essential subject matter disclosed in International Patent Application No. PCT/DK2011/000001 filed on Jan. 12, 2011 and Danish Patent Application No. PA 2010 00023 filed Jan. 13, 2010.

### TECHNICAL FIELD

The present invention relates to microfluidic analysis systems where the emitted light of an emitting source is measured by optic detection, and where a transparent body separates the emitting source from the optic detector. The invention especially relates to optic calibration of the device, the calibration being related to changes in the transparency of the transparent body and/or changes in the temperature of the emitting source.

### BACKGROUND OF THE INVENTION

Microfluidic systems are widely used, for example to measure concentrations of a substance in fluid, such as a substance in a body fluid for example glucose.

One example of such a system is found in WO 2008/089764, describing a system based on the extraction of the substances from the medium by diffusion across a semi-permeable membrane to be collected by a sweeping fluid, or perfusion fluid. This substance enriched fluid is then fed to a microfluid system, especially being formed as a microfluidic chip, where different reactions with the substances emit light at an intensity to be correlated to the concentration of the substances in the medium. An optical detector forms part of an electrical part of the system connected to the microfluidic chip, where the optical detector is positioned so that it detects the light emitted from the reactions. The electrical part and the microfluidic chip are separated by a transparent medium or body such as glass.

The importance of being able to accurately and continuously measure substance concentrations within a medium, such as tissue or some fluid like bodily fluid, is well known in the field of medical art or science. For patients suffering from diabetes it is often vital to monitor the levels of glucose, since it is known that elevated levels of glucose in the blood are indicative of conditions such as hyperglycemia and glycosuria resulting from inadequate production or utilization of insulin. Alternatively, abnormally low glucose concentrations may be an indication of overproduction of insulin. Therefore measurement of blood glucose concentration is an important tool for diagnosing, treating or controlling a variety of disorders in which the glucose concentration is known to be an indicator of the existence or severity of the condition. Situations thus exist in which the amount of insulin present is either in excess of or less than that required to handle the specific blood glucose level at any given time. Such situations are especially severe when an individual with a diabetic condition is under stress conditions, such as surgery or during childbirth.

Not only diabetics, but also non-diabetic patients may have the need of having a surveillance of their blood glucose level, like acutely ill patients treated with a pharmacologic dose of corticosteroid.

Within biotechnology other interesting applications are to maintain and control specific concentration levels of nutrients, such as glucose, in cell culture reactors, where a long-term stability is needed in order to provide feedback information required to control computerized delivery systems so that a particular chemical can be maintained within preset limits.

In a system as the one disclosed in, for example WO 2008/089764, where a transparent medium separates the optical detector from the emitting source, the state of the transparency of the transparent medium will also influence the measurements, such as if the transparent medium gets covered with dirt and moieties or simply is scratched and gets cracks. The same may be the problem of a transparent cover of the channels of the microfluidic chip of the system.

Among examples are as also described in WO 2008/089764 and its references, the document disclosing that examples of measuring the concentration of a specific chemical, such as glucose, in a solution is described in a number of documents, such as WO9939629A1 and U.S. Pat. No. 4,452,887. The latter describes a determination method where a test material or the reaction product thereof is oxidized using an oxidase enzyme, and hydrogen peroxide formed simultaneously with the oxidation is determined by various means. This has recently become important. The reason for this is that the determination of hydrogen peroxide can be accurately performed by a colorimeteric determination after a dye-forming reaction using peroxidase or by means of an electrode reaction. According to U.S. Pat. No. 4,452,887 a colorimeteric method based on the foregoing principle using a Trinder reagent is well known. In this method, hydrogen peroxide formed by the action of an oxidase enzyme is reacted with peroxidase to catalyze the oxidative coupling reaction of aminoantipyrine and a phenol and the dye thus formed is colorimetrically determined. The merit of the reaction system is that the same detection system can be utilized for different kinds of oxidase enzymes and the application of the system for various kinds of analyses is being investigated. Among these oxidase enzymes, particularly important enzymes in clinical chemistry are glucose oxidase, cholesterol oxidase, uricase, glycerol oxidase, phosphoglucose oxidase, etc.

In order to improve the systems enhancers may be introduced such as described in WO9105872A1, describing an enhanced chemiluminescent assay, in which a dihydrophthalazinedione such as luminol, a peroxidase such as HRP and an oxidant such as H2O2 are co-reacted in the presence of an enhancer such as (p)-iodophenol. The enhancer is generated by enzyme-catalysed reaction of a pro-enhancer, e.g. (p)-iodophenol phosphate is cleaved by alkaline phosphatase, enabling this enzyme to be assayed instead of peroxidase. Alternatively, the enhancer is added, an anti-enhancer such as (p)-nitrophenol is generated by enzymatic reaction of a pro-anti-enhancer such as (p)-nitrophenol phosphate and the reduction in luminescent emission is measured.

The chemi-luminescent assays are described as “enhanced” in the sense that the total light emission of the reaction and/or the signal/background ratio is larger than that obtained in the same reaction carried out in the absence of an enhancer.

### SUMMARY

The present invention introduces a method of estimating present state of the system especially for calibration purposes. This is done by introducing a device with a fluidic part comprising,
fluid communicating network,
at least a part of the fluid communicating network having a transparent wall section,
   and an electronic part comprising a detector configured in connection with the transparent part of the fluid communicating network,
wherein, the electronic part further comprises a light emitting device.

The present invention is especially, but not exclusively, suitable for devices forming part of an analysis system, especially where the analysis is based on optical detection formed by reactions in fluids present in the fluid communicating network, the detector being an optic detector.

The reactions in the fluids may be related to a concentration of specific substances to be measured by the device.

In one more specific embodiment of the present invention, the transparent wall section and the electronic part are separated by a transparent body.

In a further embodiment, the light emitting device is used to estimate the transparency of the transparent body and/or the transparent wall section by reflection.

In another or additional embodiment, the light emitting device is used to estimate the temperature of the fluid(s) in the fluid communicating network.

The correlation of the system is in a preferred embodiment of the present invention based to the estimation of the transparency, the method being to detect light emitted from the light source being scattered and reflected in and by the transparent body, and comparing the detected value(s) or spectral distribution to reference value(s) or a reference spectral distribution.

To clearly separate the correlation light from the emitted light from the reactions in the system, the light emitting device emits light at a narrow spectral span being substantially different to the light formed by the reactions in the fluids.

In one preferred embodiment, the light emitting device is a light diode.

In another preferred embodiment of the present invention, a temperature responsive element characterized by having reflection characteristics related to its temperature is positioned into or in connection with the fluid communicating network, and in further embodiment; a heating element is positioned in contact with the fluid communicating network. These may be used to estimate the temperature of the fluids and the fluid communicating network, the method being to detect light emitted from the light source being reflected by the temperature responsive element, and comparing the detected value(s) or spectral distribution to reference value(s) or a reference spectral distribution.

The present invention thus further introduces a method of regulating the temperature of the fluid of the device, wherein the method is to regulate the temperature of the heating element in accordance with the estimated temperature.

In order to improve the reflection of the emitted light to an optical detector, the present invention in another embodiment introduces that the fluidic part further comprises at least one optically reflective surface.

In one specific embodiment, the reflective surface is formed at the internal surface(s) of the fluid communicating network at least where the wall section is transparent.

In another specific embodiment, the reflective surface is formed at the side opposite to the detector of the fluid communication network at least where the wall section is transparent.

To focus the emitted light, in yet another embodiment the reflective surface is shaped having a focus point roughly at the position of the detector.

In a further embodiment of the present invention the fluidic part is a fluidic chip where ridges are formed in the surface of at least a first body, the ridges formed into channels by covering the first body with a second body having at least a transparent area.

The present invention in general relates to calibrating a system where the emitted light of an emitting source is measured by optic detection, and where a transparent body separates the emitting source from the optic detector. The invention especially relates to optic calibration of the device, the calibration being related to changes in the transparency of the transparent body and/or changes in the temperature of the emitting source.

### BRIEF DESCRIPTION OF DRAWINGS

FIG. 1 shows a typical form of a microfluidic system where the present invention may advantageously be applied.

FIG. 2 shows a transparent body separating a fluidic part from an electrical part comprising a sensor.

FIG. 3 shows how the transparency of a transparent body may change.

FIG. 4 shows the transparent body separating a fluidic part from an electrical part comprising a sensor, where the electrical part further comprises a light emitting device according to an embodiment of the present invention.

FIG. 5 shows the transparent body separating a fluidic part from an electrical part comprising a sensor, where the electrical part further comprises a light emitting device, and the microfluidic part a temperature responsive element according to a further embodiment of the present invention.

FIG. 6 shows the transparent body separating a fluidic part from an electrical part comprising a sensor, where the electrical part further comprises a light emitting device, and where the microfluidic part further comprises a focused reflecting surface within the flow communication system of the microfluidic part.

FIG. 7 shows the transparent body separating a fluidic part from an electrical part comprising a sensor, where the electrical part further comprises a light emitting device, and where the microfluidic part further comprises a focused reflecting surface below the flow communication system of the microfluidic part.

### DETAILED DESCRIPTION

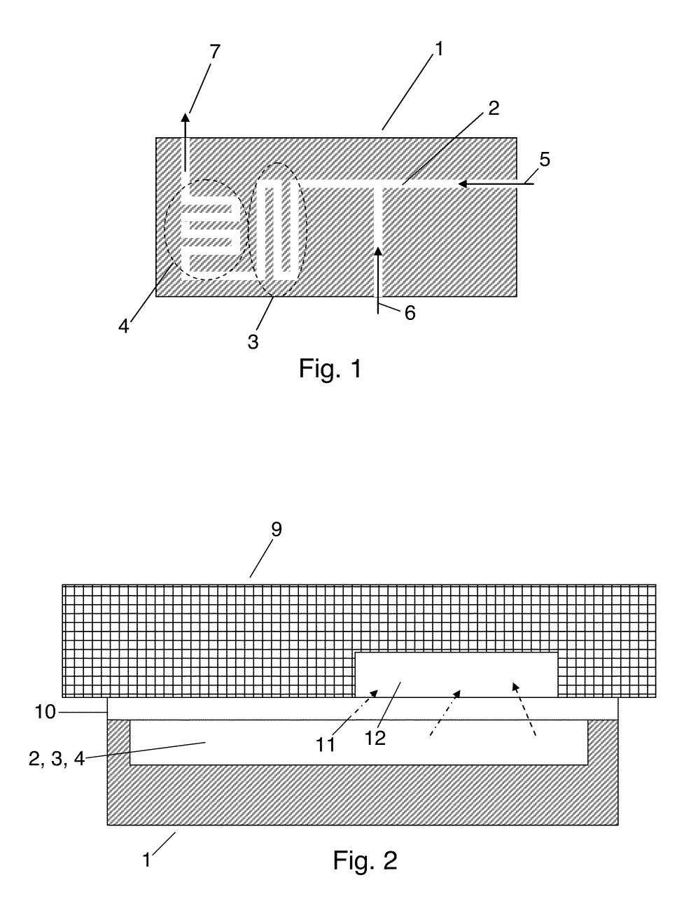

FIG. 1 shows one non-limiting example of a setup of an microfluidic analysis system whereto the present invention with advantage would apply, the system comprising a fluidic part (1) illustrated in a non-limiting example is formed as a first body with a network of grooves formed in at least one surface, where the grooves form a fluid communicating network (2) when the surface of the first body is covered with a second body (optionally a sheet, foil, etc.).

The fluid communicating network (2) may comprise any number of branches for feeding any number of different fluids (5, 6) into the system for mixing, and a mixing section (3) where the fluids gets time to mix sufficiently to give some reactions with an observable effect representative of the desired quantity to be measured. The fluid communicating network (2) may further comprise a detection section (4) where the observable effect may be measured or detected.

FIG. 2 shows a side view of the same fluidic part (2) where a cover (10) is positioned on top of the first body covering at least part of the detection section (4). The cover (10) may be the second body forming the grooves into a fluid communicating network (2), or any additional not shown such cover layers may also be present. The cover (10) would at least cover part of the detection section (4) or would cover a part of or the whole of the remaining surface of the first body of the fluidic part (1) too.

The reactions in the detection section (4) lead to an observable effect (11), where the effect non-limiting in the following description is an optical effect, such as emitting light at some spectral distribution. The cover (10) and any other optional second bodies covering the fluid communicating network (2) are transparent to the observable effect (11), at least where it/they cover(s) the detection section (4).

An electrical part (9) having an optical sensor or cell (12) is positioned on top of the fluidic part (1) such that the optical sensor (12) is at least partly aligned with the detection section (4).

One of the fluids, for example (5), may be a sample fluid, in the present context being defined as a carrier fluid enriched with substances of interest at some concentration representative of the concentration of the species in some medium. As non-limiting examples the medium may be the human tissue or waste water. The remaining of the fluids (6) may thus be reagent fluids to be mixed to the sample fluid to give some observable effect, in the following exampled as a optical effect.

The operation of this example setup could in one embodiment be that a sample fluid (5) is mixed with reagent fluid(s) (6) to emit light with an intensity corresponding to the concentration of substances. This intensity is then measured by the optical sensor (12) and the measurements are optionally processed in a computer to give an indication of the concentration of the substances of interest in the sample fluid. The fluids may finally leave the system (7) or be collected in a waste storage.

Since the measurements depend on an observable effect being correlated to the quantity to be measured, such as an optical reaction being related to the concentration of substances in a fluid, it is essential that no ‘external’ effects to the quantity affect the measurements, or at least, that they are correlated for by calibrating the system accordingly.

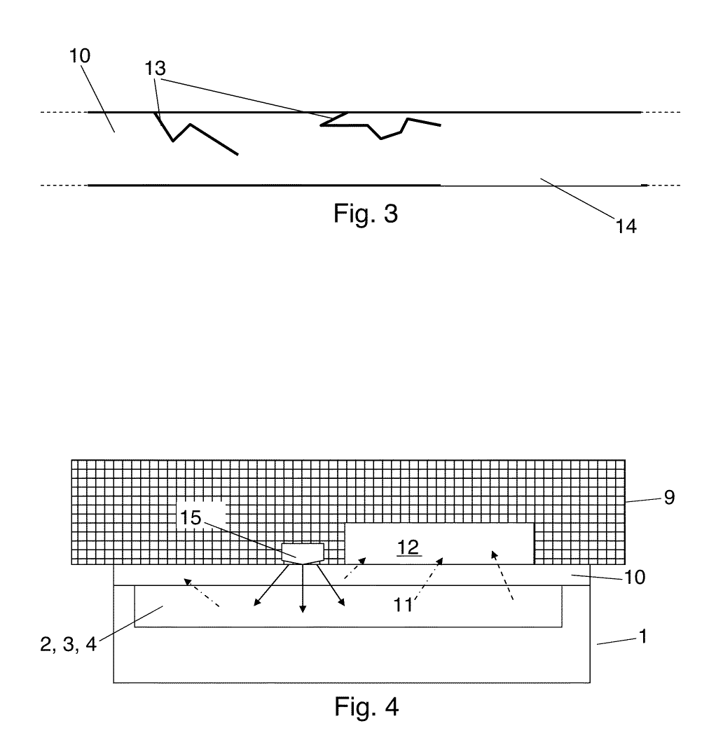

FIG. 3 illustrates some of the reasons for such ‘external’ effects, such as cracks (13) appearing in the cover (10) or moieties, dirt, substances, etc. (14) depositing on the surfaces of the cover (10), all of them influencing the transparency of the cover (10), and therefore, for example the emitted light from the reactions will be inhibited from reaching the optical sensor (12) thereby ‘lowering’ the measured concentration of substances in the sample fluid.

FIG. 4 shows a first aspect in one preferred embodiment of the present invention, where a light emitting device (15), such as but not excluded to a light diode, is included in the electrical part (9). The light emitting device (15) preferably emits light within a specified narrow spectral span substantially different from the light emitted by the reactions (11), and with a well known intensity.

The light emitted by the light emitting device (15) will be scattered in the system of cover (11), channels (2, 3, 4) and the main body of the fluidic part (1), and a fraction of it will be measured by the optical sensor (12). Thus the light emitted by the light emitting device (15) will be affected in the same manner by ‘external’ effects like (13) and (14) as the light emitted by the reactions (11).

The idea of the invention therefore is from time to time to emit light by the light emitting device (15) and use the intensity measured by the optical sensor (12) to estimate the present transparency of the cover (10) (and other optional covers/second bodies), using this for calibration purposes. Optionally, a threshold limit could be introduced to give off a signal when the measured intensity gets below this threshold limit, indicating the system may no longer operate properly, and should be exchanged, repaired or cleaned.

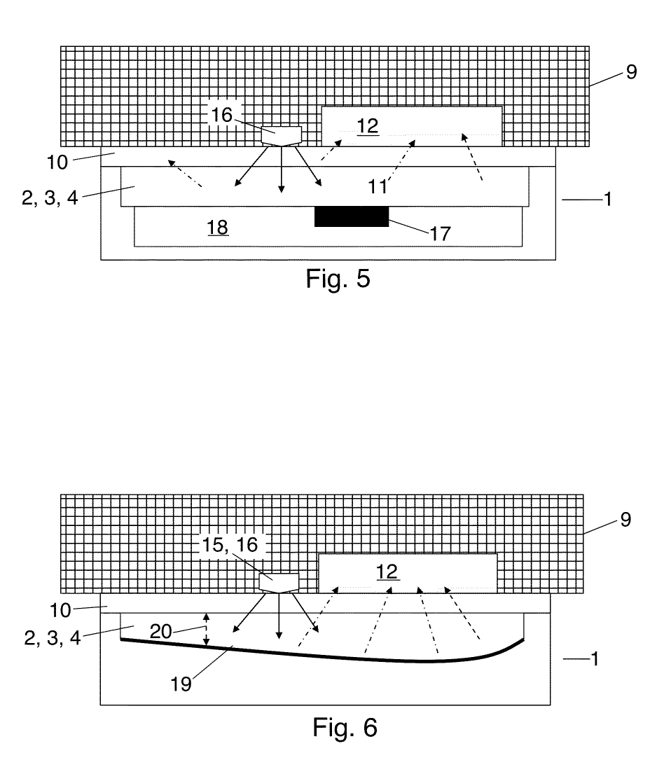

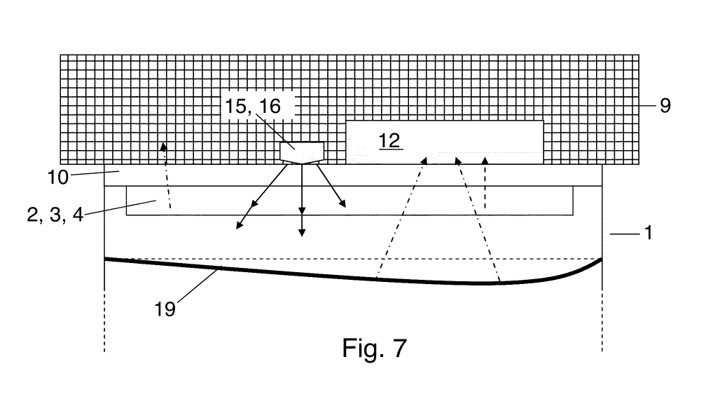

A further aspect of the present invention illustrated in FIG. 5, is related to temperature dependencies in the light emission (11) from the reactions in the mixed fluids, this also being due to changing viscosities of the fluids, leading to changing flow rates. It would therefore be an advantage at least to be able to estimate the present temperature of the mixed fluids, especially, but not excluded to, being present in the reaction section (4). The idea of the present invention is to use a light emitting device (16) to estimate the temperature by introducing in the fluid communicating network (2), especially in contact with the detection section (4), a temperature responsive element (17) characterized by having reflection characteristics related to its temperature.

With given intervals the light emitting device (16) emits light and the reflected light from the temperature responsive element (17) is measured by the optical sensor (12) and the temperature of the temperature responsive element (17), being in contact with and therefore related to the temperature of the fluids in the fluid communication network (2), is calculated.

In one preferred embodiment a heating and/or cooling element (18) is positioned in contact with the fluid communicating network (2), especially in contact with the detection section (4). This element will then be controlled in its heating and/or cooling in response to the temperature measurements, thereby making it possible to regulate the temperature of the fluids to a desired temperature.

The light emitting device (16) used for temperature measurements may be the same device as the light emitting device (15) used to measure the transparency of the cover (10), optionally able to emit light at two different spectral spans, one used to estimate the transparency of the cover (10), and one used for temperature measurements.

In another embodiment two separate light emitting devices (15) and (16) are introduced in the system.

In yet another embodiment of the present invention, the fluidic part (1) comprises at least one reflective surface (19). In one embodiment shown in FIG. 5 this at least one reflective surface (19) is formed at the bottom of the fluid communicating network (2), preferably at the detection section (4).

Further, in a preferred embodiment, the reflective surface (19) is shaped in such a manner that it comprises a focus point being located at the optical sensor (12). If, for example, the at least one reflective surface (19) is formed in the bottom surface of the channel(s) of the detection section (4) (or part of or the whole of the fluid communicating network (2)), this shaping with a focus point may be formed by shaping the heights (20) of the channel(s) by introducing varying heights (20) so that the bottoms of the channels would ‘fit’ to a parabolic surface.

FIG. 6 shows an alternative way of introducing a reflective surface (19) especially suited when the material of the first body of the fluidic part (1) is of an at least partly transparent material. The reflective surface (19) then could be introduced below the fluid communicating network (2), for example, at the bottom surface of the first body of the fluidic part (1), or even within this first body.

The present invention may comprise one of or any combination of the embodiments described above.

Although the invention above has been described in connection with a preferred embodiment of the invention, it will be evident for a person skilled in the art that several modifications are conceivable without departing from the invention as defined by the following claims.

What is claimed is:

1-15. (canceled)

16. An analysis device for analyzing fluids by optical detection of reactions in fluids, the analysis device having:
a fluidic part comprising a fluid communicating network, where at least a part of the fluid communicating network has a transparent wall section, and a temperature responsive element having reflection characteristics related to its temperature is positioned in connection with the fluid communicating network and in contact with the fluids therein its temperature thus related to the temperature of the fluids; and
an electronic part comprising an optical sensor and a light emitting device configured in optical communication with fluids within the fluid communication network through the transparent wall section;
wherein the analysis device is adapted to estimate the temperature of the fluids in the fluid communicating network by the optical sensor detecting the light emitted light from the light emitting device being reflected by the temperature responsive element, and where the light emitting device and optical sensor additionally is used for estimating the transparency of the transparent wall section by the optical sensor measuring the light emitted by the emitting device being reflected within the transparent wall section.

17. The analysis device according to claim 16, wherein the fluids are a mix of a sample fluid with reagent fluid(s) reacting with the substances of interest in the sample fluid to emit light with an intensity corresponding to the concentration of these substances of interest.

18. The analysis device according to claim 16, wherein the transparent wall section is a cover of the fluid communicating network.

19. The analysis device according to claim 16, wherein the light emitting device emits light at a narrow spectral span being substantially different to the light formed by the reactions in the fluids.

20. The analysis device according to claim 16, wherein the same light emitting device is used for the temperature measurements for measuring the transparency of the wall section.

21. The analysis device according to claim 20, wherein the light emitting device is able to emit light at two different spectral spans, one used to estimate the transparency of the wall section and one used for temperature measurements.

22. The analysis device according to claim 16, wherein two separate light emitting devices and are introduced in the system.

23. The analysis device according to claim 16, wherein the estimation of the transparency of the transparent wall section is used to calibrate the analysis device.

24. The analysis device according to claim 16, wherein a heating and/or cooling element is positioned in contact with the fluid communicating network to regulated the temperature of the fluids to a desired temperature.

25. The analysis device according to claim 24, wherein the temperature of the fluids and the fluid communicating network is estimated detect light emitted from the light source being reflected by the temperature responsive element, and comparing the detected value(s) or spectral distribution to reference value(s) or a reference spectral distribution.

26. The analysis device according to claim 25, wherein the temperature of the heating and/or cooling element is regulated in accordance with the estimated temperature of the fluids.

27. The device according to claim 16, wherein the fluidic part further comprises at least one optically reflective surface formed at the internal surface(s) of the fluid communicating network at least where the wall section is transparent and wherein the reflective surface is shaped having a focus point roughly at the position of the optical sensor.

28. The device according to claim 16, wherein the fluidic part is a fluidic chip where ridges are formed in the surface of at least a first body, the ridges formed into channels by covering the first body with a second body having at least a transparent area.
